(19) United States
(12) Patent Application Publication
(10) Pub. No.: US 2001/0004493 A1
(43) Pub. Date: Jun. 21, 2001

(54) MOLDED FOAM PAD WITH INTEGRAL WIRING

(76) Inventor: JEFFREY A. BRANCH, EASTPOINTE, MI (US)

Correspondence Address: THEODORE W OLDS, HOWARD AND HOWARD, SUITE 101, 1400 NORTH WOODWARD AVENUE, BLOOMFIELD HILLS, MI, 483042856

(21) Appl. No.: 09/263,376

(22) Filed: Mar. 5, 1999

(51) Int. Cl. B32B 3/00; B32B 3/26

(52) U.S. Cl. 428/317.9; 428/71; 428/304.4

(57) ABSTRACT

An improved method of forming vehicle pads to incorporate wire harness includes molding the wire harness with the pad such that the wire harnesses are embedded in the pad. In this way, the pad may be integrally mounted with the wire harnesses, and there are less components to assemble. Moreover, the sealing is better and there is less likelihood of unwanted noise. The pads are preferably under hood or dash pad applications for vehicles.

### BACKGROUND OF THE INVENTION

This invention relates to a vehicle having a pad received adjacent a metal plate, wherein the pad is formed of a closed cell foam molded to incorporate a wire harness.

Vehicles are becoming equipped with more and more electrical controls and features. Typically, modern vehicles are provided with wire harnesses for routing the wires between power supply, control switches, and items which are to be controlled. Wire harnesses are typically found in many locations on the vehicle, and typically include connectors at both an inlet and an outlet end.

One location where there are a number of electrical connectors is within the engine compartment of the vehicle. A structural member, known as a fire wire, separates the hood interior from the cabin of the vehicle. Further, a number of wire harnesses must pass through the firewall of the vehicle.

Vehicles are also provided with thermal or acoustic pads which underlie the structural members such as the hood, or the firewall. The firewall has typically been provided with a pad either inside or outside of the firewall, and in some cases, both. These pads must allow wire harnesses to extend through the firewall, and further typically seal around the wire harnesses.

To date, the separate wire harnesses have been utilized that require separate assembly, and further sometimes result in rattling and leaking. That is, with the prior art, the wire harnesses have been separate from the various pads which are attached to the structural members. The wire harnesses must thus pass through the pads, and can result in leakage. Further, the wire harnesses can become loose and result in rattling.

Similarly, fluid connections are also provided under the hood, such as to provide a washer fluid to the hood for delivery to a vehicle windshield. Again, this has typically been provided by a separate part.

### SUMMARY OF THE INVENTION

In the disclosed embodiment of this invention, a pad to be attached to a structural member of a vehicle is integrally molded of a closed cell foam with a wire harness. The structural member defines a part of the engine compartment. The molding of the wire harness with the pad encapsulates the wire harness, protecting and securely holding the wire harness. Moreover, the pad and wire harness can now be assembled as a single item. Further, the wire harness will not result in extra passages through the pad, which could result in leaking. Finally, the wire harness will not become loose relative to the pad which could result in unwanted noise.

In a preferred embodiment of this invention, the pad is a dash pad which is secured to an inner side of the vehicle firewall. The dash pad is molded to incorporate a wire harness, and pigtail connectors are formed on the dash pad for attachment to various structures under the hood of the vehicle.

In a further embodiment, the pad is an under hood pad which is integrally molded with a wire harness and lamp. Further, this embodiment is preferably integrally molded with a fluid supply pipe which would supply a wiper fluid through the hood for being directed onto the windshield.

These and other features of the present invention can be best understood from the following specification and drawings, the following of which is a brief description.

### BRIEF DESCRIPTION OF THE DRAWINGS

FIG. 1 is a schematic cross sectional view through a vehicle frame.

FIG. 2 is a view of a dash pad according to the present invention.

FIG. 3 is a side partial view of the FIG. 2 embodiment.

FIG. 4 shows another embodiment of the present invention.

FIG. 5 shows a mold schematically utilized to form the inventive embodiment.

### DETAILED DESCRIPTION OF A PREFERRED EMBODIMENT

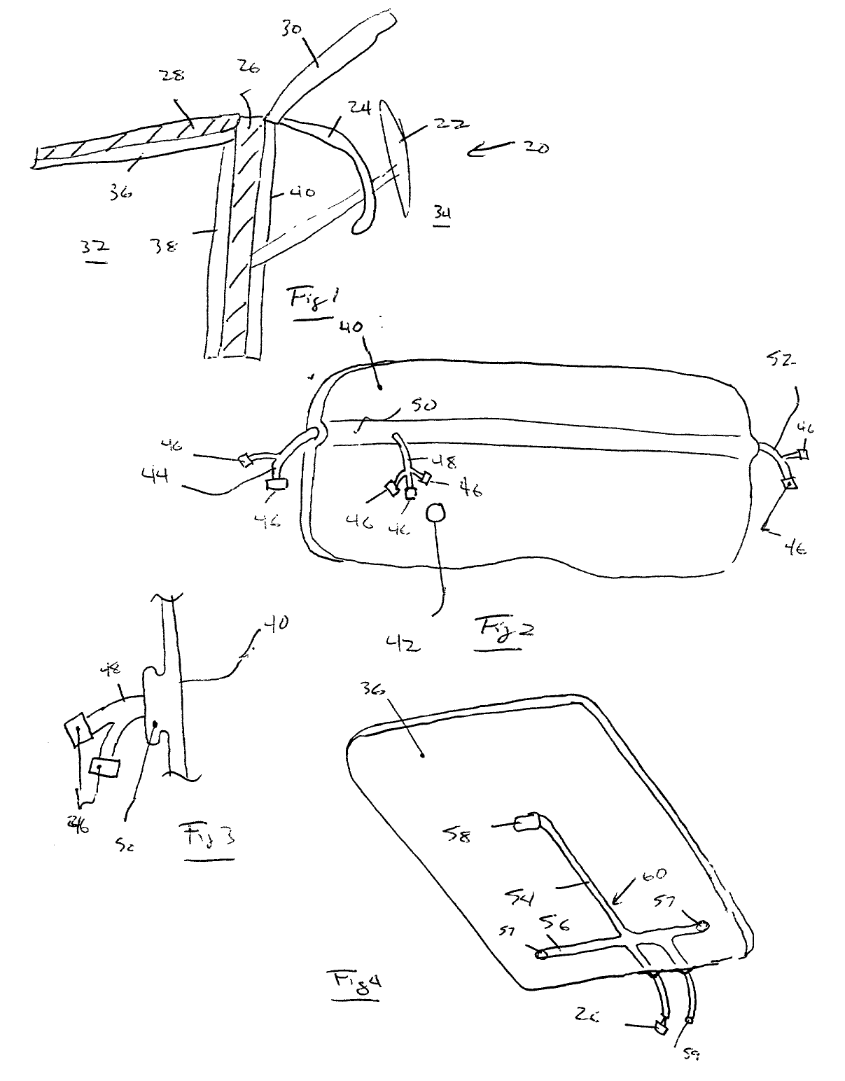

Vehicle 20 is illustrated in FIG. 1 having a steering wheel 22 and an instrument panel 24 as known. A firewall 26 is shown adjacent to a hood 28 and a windshield 30. The structure of these members is as known in the arts, and is only shown schematically here for a basic location of the inventive pads.

An engine compartment 32 is separated from a passenger compartment 34 by the firewall 26. An under hood pad 36 is positioned under the hood 28 and a dash pad 40 is positioned toward compartment 34 from firewall 26. In some applications, a second dash pad 38 may be positioned inwardly of the firewall 26.

As should be appreciated, a number of wires must pass through the firewall 26. As shown in FIG. 2, the dash pad 40 incorporates grommets such as grommet 42 for passage of additional wires, or also passage of the steering column, etc.

A pigtail 44 extending from an encapsulated wire harness includes connectors 46 at an end. As is known, the wire harness might have other pigtails 48 and 52 with their own respective connectors 46 at different locations. A ramp or mound 50 is formed in the otherwise generally planar pad 38 to encapsulate the wire harness.

It should be understood that the connectors 46 can pass through firewall 26 and face into the compartment 32, and can be easily connected to various components.

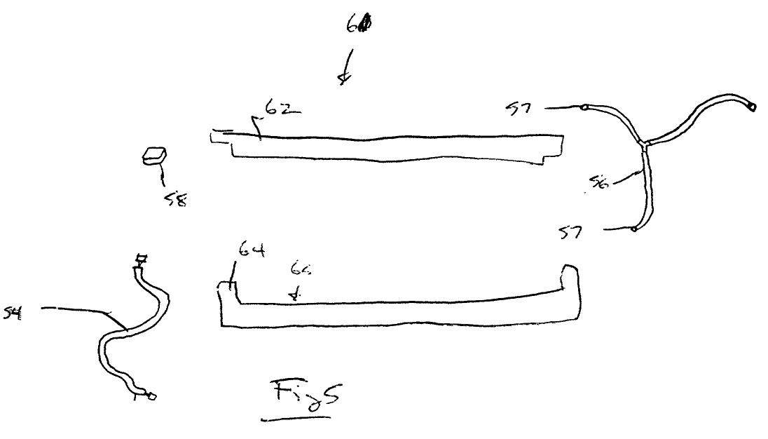

FIG. 3 is a cross-sectional view showing mound 50 incorporating the connectors 46.

FIG. 4 shows underhood pad 36. Tab 36 is molded to incorporate a wire harness 54 providing electrical connections to a under hood lamp 58. Further, a fluid connection 56 extends to fluid outlet 57 from a fluid inlet 59. The fluid outlets 57 are the outlets which supply fluid to structure which communicate outwardly of the hood of the vehicle and onto the windshield of the vehicle. The outlet 57 communicate with openings in hood, as known.

As shown, mound 60 encapsulating the fluid connection 56, wire harness 54 and lamp 58, and extends outwardly from the generally planar pad 36.

The under hood pad is typically a thermal pad formed of an appropriate foam to achieve the function of the thermal pad. The dash pad is preferably formed of an appropriate foam for insulating the vehicle passenger compartment from the vehicle engine compartment both thermally and acoustically.

In preferred embodiments, the pad is formed of a closed cell foam which encapsulates the wire harness and fluid connectors.

FIG. 5 shows a schematic view of a mold 61 having mold portion 62 and 64 to define a mold space 66. As shown, the components 54, 56 and 58 are mounted into the mold space 66, and held by known structure. The closed cell foam is then molded around the components to form the pad 36 and embed the components. The embodiment of FIG. 2 can be molded in a similar way.

Although a wire harness has been preformed as illustrated in the preferred embodiment, it should be understood that the wires could be individually assembled into the mold prior to the foaming to form the pad, and the coverings for the wires to be formed at that same time. Examples of such foamed wire harness technology are shown for example in U.S. patent application Ser. No. 08/898,663 owned by the assignee of the present invention.

Although preferred embodiments of this invention have been disclosed, it should be understood that various modifications come within the scope of this invention. For that reason, the following claims should be studied to determine the true scope and content of this invention.

What is claimed is:

1. A hood defining a hood compartment in combination with a firewall;
a foam pad received adjacent a component defining said hood compartment, said foam pad being integrally molded with wires to encapsulate said wires.

2. A vehicle as recited in claim 1, wherein said foam pad is mounted on an underside of a hood.

3. A vehicle as recited in claim 2, wherein said foam pad is molded to incorporate a light which communicates with said wires.

4. A vehicle as recited in claim 2, wherein a fluid connection is also molded with said pad to supply fluid through said pad and to connections in said hood.

5. A vehicle as recited in claim 1, wherein said wires extend upwardly from a generally planar pad surface once said wire harness has been encapsulated in said pad.

6. A vehicle as recited in claim 1, wherein said pad is mounted to a surface of a firewall facing into a vehicle cab.

7. A vehicle as recited in claim 6, wherein said pad incorporates wires extending along the length of said pad and having pigtail connectors extending outwardly of said pad at distinct locations.

8. A vehicle as recited in claim 1, wherein said wires are preformed into a wire harness prior to being molded into said pad.

9. A pad for incorporation into a vehicle comprising:
a generally planar pad body, said pad being molded of a foam material; and
a transmission member integrally molded with said pad, said transmission member communicating at least one of a fluid or electric signals, and being embedded in said pad over at least a portion of said transmission member.

10. A pad as recited in claim 9, wherein said transmission member is an electrical wire.

11. A pad as recited in claim 10, wherein said transmission member is also a fluid supply member.

12. A pad as recited in claim 10, wherein said electrical wire is a wire harness containing a plurality of electrical wires.

13. A pad as recited in claim 9, wherein said transmission member is a fluid supply member.

14. A pad as recited in claim 9, wherein said pad is utilized on an under surface of a vehicle hood.

15. A pad as recited in claim 10, wherein said pad is molded to incorporate a light which communicates with said electrical wires.
